(19) United States
(12) Patent Application Publication
(10) Pub. No.: US 2007/0174525 A1
(43) Pub. Date: Jul. 26, 2007

(54) LOW POWER MULTIMEDIA PLAYING METHOD FOR PORTABLE COMPUTER

(75) Inventors: Robert Han Liu, Shenzhen (CN); Kuan-Hong Hsieh, Shenzhen (CN); Han-Che Wang, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/561,854

(22) Filed: Nov. 20, 2006

(30) Foreign Application Priority Data
Dec. 30, 2005 (CN) 200510121400.9

(51) Int. Cl. G06F 13/38

(52) U.S. Cl. 710/72

(57) ABSTRACT

A low power multimedia playing system is provided. The system includes a portable computer and a portable media player. The portable computer includes an activation switch, an interface, a storage unit, a microcontroller, and a bus controller. The activation switch is for a function of playing audio files. The storage unit is for storing the audio files. The interface configured is for communicating with the portable media player. The microcontroller is operated when the portable computer is not powered, and is programmed for controlling the media player connected thereto to play the audio files stored in storage unit. The bus controller configured is for controlling a battery to supply power to the storage unit and the microcontroller, in response to an operation on the activation switch.

### BACKGROUND

1. Technical Field

The present invention relates to portable computers, and particularly to a portable computer adapted for low power operation while playing multimedia files and a method of operating the portable computer.

2. General Background

Personal computers have become indispensable tools for business and personal use. Portable personal computers, generally known as “laptop”, or “notebook” computers have become increasingly popular because their portability allows access to the wide variety of computer applications when traveling, such as on airplanes. However, the usefulness of such portable computers is limited by the power life of batteries powering the computers. Therefore, extending the power life of the batteries becomes a critical problem.

Presently, portable computers carry power-saving functions to solve problems related to inefficient or wasteful power usage. When the computer system remains idle over a certain time period, the computer system power is shut down to conserve power. Generally, the computer system switches to a power-saving mode automatically when idled for a time period preset by the user. When the user wishes to resume a use of the portable computer, the computer system “wakes up”, switching to a normal working mode and supplying power to all components.

However, while in the power-saving mode, the computer is not operable. As a result, the CPU cannot use any audio applications to play music in the power-saving mode. Therefore, if the user wants to play music, the computer system must be in the normal working mode, thus power is supplied to all components. However, while playing music, other functions or devices in the computer system may not be required. Power supplied to corresponding components at this time may be unnecessary.

What is needed, therefore, is a computer system and method adapted for low power consumption while playing music. The system and method is capable of only powering associated components to play music while the other components in the system remain in a power off mode, thus reducing power consumption.

### SUMMARY

A portable computer is provided. The portable computer includes an activation switch, a storage unit, an interface, a central processing unit, a microcontroller, and a bus controller. The activation switch is for a function of playing audio files. The storage unit is for storing the audio files. The interface is configured for communicating with an external portable media player. The central processing unit is configured for running the portable computer. The microcontroller has substantially lower performance and power consumption than the central processing processor and is operated when the portable computer is not powered. The microcontroller is programmed for controlling the external portable media player connected thereto to play the audio files stored in storage unit. The bus controller is configured for controlling a battery to supply power to the storage unit and the microcontroller, in response to an operation on the activation switch

Other advantages and novel features will be drawn from the following detailed description with reference to the attached drawing, in which:

### BRIEF DESCRIPTION OF THE DRAWINGS

FIG. 1 is a schematic diagram of a hardware infrastructure of a portable computer in accordance with a preferred embodiment of the present invention;

FIG. 2 is a schematic diagram of a hardware infrastructure of a portable media player in accordance with a preferred embodiment of the present invention; and

FIG. 3 is a flowchart of a preferred low power method for playing audio files, by utilizing the portable computer of FIG. 1 and the portable media player of FIG. 2.

### DETAILED DESCRIPTION OF THE EMBODIMENT

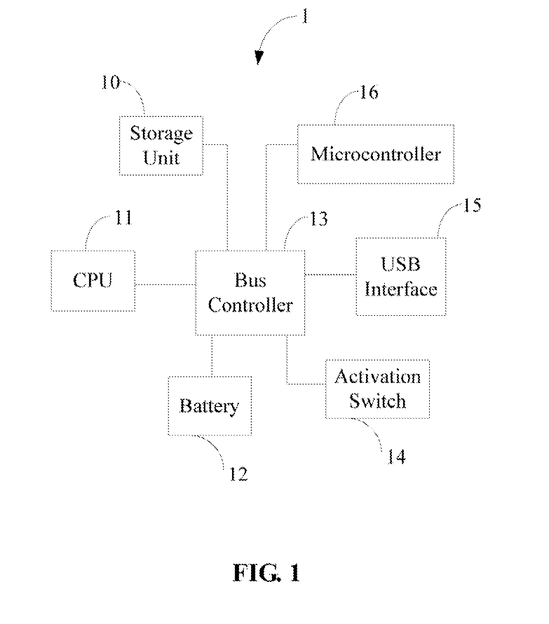

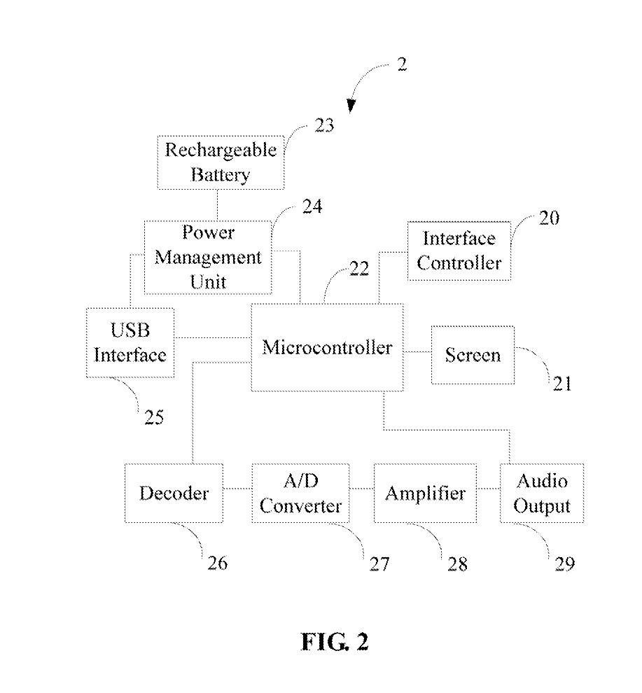

Referring to FIGS. 1 and 2, a portable computer and a portable media player are respectively disclosed. The portable computer 1 includes a storage unit 10, a CPU (central processing unit) 11, a battery 12, a bus controller 13, an activation switch 14, a computer interface 15 (e.g., a USB interface as shown in FIG. 1), and a microcontroller 16. The storage unit 10 is for storing information such as audio files. The activation switch 14 is configured for a specific function of playing audio files. The CPU 11 is configured for running an operating system of the portable computer 1. The microcontroller 16 has substantially lower performance and power consumption than the CPU 11 and is operated when the portable computer 1 is not powered.

The bus controller 13 is configured (i.e., structured and arranged) to connect with the storage unit 10, the CPU 11, the battery 12, and the microcontroller 16. The bus controller 13 is for controlling the battery 12 to supply power to components relating to a specific operation on the portable computer 1.

For example, in response to an operation on a power switch (not shown) of the portable computer 1, the bus controller 13 controls the battery 12 to supply power to the storage unit 10 and the CPU 11, thereupon, the CPU 11 runs the operating system of the portable computer 1.

In response to an operation on the activation switch 14, the bus controller 13 supplies power to the storage unit 10, the computer interface 15, and the microcontroller 16 from the battery 12, thereupon, the microcontroller 16 is able to obtain the audio files from the storage unit 10, and transmit the audio files obtained to the portable media player 2 connected thereto through the computer interface 15.

The portable media player 2 includes an interface controller 20, a screen 21, a player microcontroller 22, a rechargeable battery 23, a power management unit 24, a player interface 25 (e.g., a USB interface as shown in FIG. 2), a decoder 26, an A/D converter 27, an amplifier 28, and an audio output 29. The interface controller 20 is for generating signals to control power on/off, play, volume adjustment, etc, in response to operational inputs. The player interface 25 is for performing communication with an external electronic device such as, for example, the portable computer 1. The player interface 25 is further configured to connect with the player microcontroller 22 and the power management unit 24.

When the portable media player 2 is used as an independent electrical device, the components of the portable media player 2 obtain power from the rechargeable battery 23 and cooperate to perform an audio playing function. That is, the power management unit 24 supplies power to the components relating to the audio playing function from the rechargeable battery 23, then the player microcontroller 22 obtains audio files from a memory (not shown) of the portable media player 2 and signals the decoder 26 to decode the audio files into digital audio signals, the A/D converter 27 then converts the digital audio signals into analog audio signals, and the amplifier 28 amplifies the analog audio signals and outputs the audio signals amplified via the audio output 29.

When the portable media player 2 is used as a peripheral device of the portable computer 1, the portable computer 1 and the portable media player 2 cooperate as an audio playing system. That is, in response to the operation on the activation switch 14, the microcontroller 16 obtains the audio files from the storage unit 10 and transmits the audio files obtained to the portable media player 2 through the computer interface 15. The portable media player 2 decodes the audio files received from the portable computer 1, and outputs the audio signals corresponding to the audio files decoded. Simultaneously, the portable media player 2 is powered by the portable computer 1 (i.e., the battery 12) to drive the components thereof through the player interface 25. Furthermore, power from the portable computer 1 may also be used to recharge the rechargeable battery 23, if needed.

In the audio playing system, the portable computer 1 only powers the components relating to the audio playing function (e.g., the storage unit 10, the computer interface 15, the microcontroller 16, and the portable media player 2), thereby saving power consumption from the battery 12. In addition, due to a relatively higher capacity of the storage unit 10, the portable computer 1 can hold a larger number of audio files than the portable media player 2. Therefore, by utilizing the audio playing system, a user of the portable computer 1 and the portable media player 2 can enjoy many more audio files than that by using the portable media player 2 independently, furthermore, the user can enjoy the audio files with a relatively lower power consumption, as compared to a conventional audio playing system where the conventional portable computer powers all unnecessary components when playing audio files.

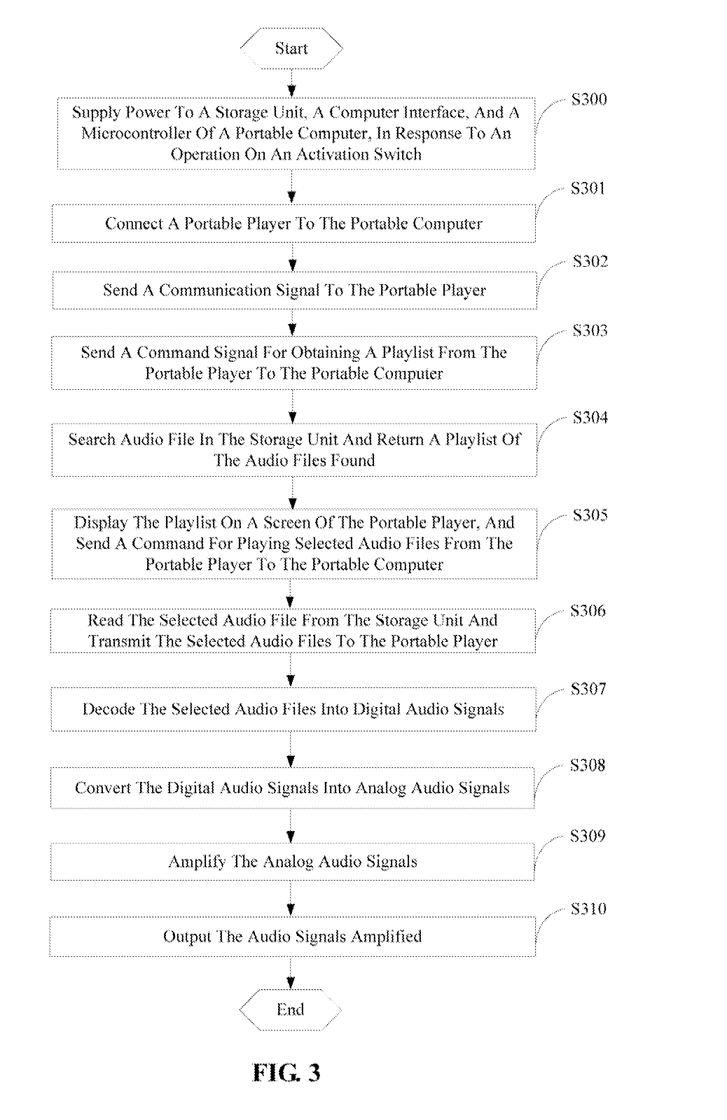

FIG. 3 is a flowchart of a preferred low power method for playing audio files, by utilizing the portable computer 1 and the portable media player 2. In an initialization state, the portable computer 1 is in a power off state. In step S300, the bus controller 13 supplies power to the storage unit 10, the computer interface 15, and the microcontroller 16 with the battery 12 in response to the operation on the activation switch 14.

In step S301, the portable media player 2 is connected to the portable computer 1 by connecting the player interface 25 with the computer interface 15.

In step S302, the microcontroller 16 of the portable computer 1 sends a communication signal to the portable media player 2, and the player microcontroller 22 recognizes the communication signal, and regards the portable computer 1 as an external storage.

In step S303, the interface controller 20 generates a playlist signal in response to a playlist operational input, and signals the player microcontroller 22 to send a command to the portable computer 1 for obtaining a playlist.

In step S304, the microcontroller 16 of the portable computer 1 searches audio files in the storage unit 10, and returns a playlist of the audio files found to the portable media player 2.

In step S305, the player microcontroller 22 displays the playlist on the screen 21. The interface controller 20 generates a play signal in response to a play operational input, and signals the player microcontroller 22 to send a command for playing selected audio files to the portable computer 1.

In step S306, the microcontroller 16 of the portable computer 1 reads the selected audio files from the storage unit 10, and transmits the selected audio files to the portable media player 2.

In step S307, the decoder 26 decodes data of the selected audio files into digital audio signals, and transmits the digital audio signals to the A/D converter 27.

In step S308, the A/D converter 27 converts the digital audio signals into analog audio signals, and transmits the analog audio signals to the amplifier 28.

In step S309, the amplifier 28 amplifies the analog audio signals thereby yielding amplified audio signals. In step S310, the audio output 29 outputs the amplified analog audio signals.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. A portable computer comprising:
an activation switch for a function of playing audio files;
a storage unit for storing the audio files;
an interface configured for communicating with an external portable media player;
a central processing unit configured for running the portable computer;
a microcontroller, which has substantially lower performance and power consumption than the central processing processor and is operated when the portable computer is not powered, programmed for controlling the external portable media player connected thereto to play the audio files stored in storage unit; and
a bus controller configured for controlling a battery to supply power to the storage unit and the microcontroller, in response to an operation on the activation switch.

2. The computer according to claim 1, wherein the bus controller further controls the battery to supply power to the external portable media player connected thereto through the interface.

3. A low power multimedia playing system comprising:
a portable computer and a portable media player;
wherein the portable computer comprises:
an activation switch for a function of playing audio files;
a storage unit for storing the audio files;
a computer interface configured for communicating with the portable media player;
a microcontroller, which is operated when the portable computer is not powered, programmed for controlling the portable media player connected thereto to play the audio files stored in storage unit; and
a bus controller configured for controlling a battery to supply power to the storage unit and the microcontroller, in response to an operation on the activation switch; and
the media comprises a player interface for connecting with the computer interface, thereby communicating with the portable computer.

4. The system according to claim 3, wherein the bus controller further controls the battery to supply power to the portable media player connected thereto through the computer interface and the player interface.

5. The system according to claim 4, wherein the portable media player plays the audio files from the portable computer in response to a play operational input.
